(19) United States
(12) Patent Application Publication
(10) Pub. No.: US 2012/0147506 A1
(43) Pub. Date: Jun. 14, 2012

(54) METHOD OF DETECTING AN UNINTENTIONAL ISLAND CONDITION OF A DISTRIBUTED RESOURCE OF A UTILITY GRID, AND PROTECTIVE APPARATUS AND CONTROLLER INCLUDING THE SAME

(76) Inventor: TIMOTHY HEDQUIST, Sugar Hill, GA (US)

(21) Appl. No.: 12/967,688

(22) Filed: Dec. 14, 2010

(51) Int. Cl. H02H 7/06

(52) U.S. Cl. 361/21

(57) ABSTRACT

A protective apparatus is for a distributed resource of a utility grid. The protective apparatus includes a processor having an input structured to input frequency of the distributed resource, a first output structured to control speed of the distributed resource, a second output, and a routine structured to actively bias engine-generator speed of the distributed resource through the first output, and detect a predetermined change in the frequency of the distributed resource from the input and responsively indicate the unintentional island condition through the second output. The protective apparatus also includes a circuit interrupter.

### BACKGROUND

1. Field

The disclosed concept pertains generally to utility grids and, more particularly, to protective apparatus for distributed resources, such as, for example, engine-generators. The disclosed concept also pertains to methods of detecting an unintentional island condition of a distributed resource of a utility grid. The disclosed concept further pertains to controllers for such distributed resources.

2. Background Information

Currently, industrial countries generate most of their electricity in relatively large centralized facilities, such as fossil fuel (e.g., without limitation, coal; gas powered), nuclear or hydropower plants. These power plants have excellent economies of scale, but usually transmit electricity relatively long distances, and can negatively affect the environment.

Distributed generation, also called on-site generation, dispersed generation, embedded generation, decentralized generation, decentralized energy or distributed energy, generates electricity from many relatively small energy sources. With the recent development of the U.S. “Smart Grid”, “MicroGrids” and other methods of supplementing the output of utility power resources, distributed resources, such as for example and without limitation, bio-gas power generation, have become more common These distributed resources generate electric power and export it to the utility grid.

FIG. 1 shows a typical distributed resource application. Under normal conditions, each distributed resource (DR) 2, 4 exports power 3, 5 to an area electric power system (EPS) 6 and to the utility grid 14 through a corresponding point of common coupling (PCC) 8 (e.g., without limitation, a generator tie circuit breaker).

Protection for life and safety is provided in a distributed resource system. An “unintentional island” condition can exist when: (1) a distributed resource is exporting power to the utility grid; (2) the power exported by the distributed resource exactly equals the power consumed by a number of connected grid loads; and (3) the sub-station switch at the utility sub-station is opened.

IEEE 1547™—IEEE Standard for Interconnecting Distributed Resources with Electric Power Systems provides in Section 4.4.1 (Unintentional islanding) that for an unintentional island in which a distributed resource (DR) energizes a portion of an area electric power system (EPS) through a point of common coupling (PCC), the DR interconnection system shall detect the island and cease to energize the area EPS within two seconds of the formation of an island.

IEEE 1547™ also provides that the “DR contains other non-islanding means, such as a) forced frequency or voltage shifting, b) transfer trip, or c) governor and excitation controls that maintain constant power and constant power factor.”

Referring to FIG. 2, each of the distributed resources 2,4, such as an engine-generator, is connected to a utility source (not shown) and exports electric power 3,5 to the area EPS 6 and to the utility grid 14. Under certain conditions, the utility sub-station switch 10 can be opened (as is shown in FIG. 2) with the intent of de-energizing the downstream grid, which is the area EPS 6. This action will go unnoticed by the distributed resources 2,4. The downstream grid 6 remains energized causing an unintentional island to be formed. Hence, an unintentional island is formed when the switch 10 at the utility sub-station 12 is opened and the distributed resources 2 and/or 4, for example, continue to power the area EPS 6.

There is room for improvement in protective apparatus for distributed resources, such as, for example, engine-generators.

There is also room for improvement in methods of detecting an unintentional island condition of a distributed resource of a utility grid.

There is further room for improvement in controllers for distributed resources.

### SUMMARY

These needs and others are met by embodiments of the disclosed concept, which actively bias engine-generator speed of a distributed resource, and detect a predetermined change in frequency of the distributed resource and responsively indicate the unintentional island condition.

In accordance with one aspect of the disclosed concept, a method of detecting an unintentional island condition of a distributed resource of a utility grid comprises: actively biasing engine-generator speed of the distributed resource; and detecting a predetermined change in frequency of the distributed resource and responsively indicating the unintentional island condition.

The method may further comprise disconnecting the distributed resource from the utility grid responsive to the detecting.

The method may further comprise providing the detecting and the disconnecting within two seconds of formation of the unintentional island condition.

The method may further comprise employing an engine-generator as the distributed resource; and providing no impact to the engine-generator during normal operation without the unintentional island condition.

The method may further comprise providing no undue wear to a number of components of the engine-generator during normal operation without the unintentional island condition.

The method may further comprise performing the detecting by sensing frequency deviation of the engine-generator above or below predetermined limits.

The method may further comprise employing as the actively biasing engine-generator speed periodically adjusting the speed bias by a predetermined percentage thereof.

As another aspect of the disclosed concept, a protective apparatus is for a distributed resource of a utility grid. The protective apparatus comprises: a processor comprising: an input structured to input frequency of the distributed resource, a first output structured to control speed of the distributed resource, a second output, and a routine structured to actively bias engine-generator speed of the distributed resource through the first output, and detect a predetermined change in the frequency of the distributed resource from the input and responsively indicate the unintentional island condition through the second output; and a circuit interrupter.

As another aspect of the disclosed concept, a controller is for a distributed resource of a utility grid. The controller comprises: a processor; an input structured to input frequency of the distributed resource; a first output structured to control speed of the distributed resource; a second output; and a routine executed by the processor and structured to actively bias engine-generator speed of the distributed resource through the first output, and detect a predetermined change in the frequency of the distributed resource from the input and responsively indicate the unintentional island condition through the second output.

### BRIEF DESCRIPTION OF THE DRAWINGS

A full understanding of the disclosed concept can be gained from the following description of the preferred embodiments when read in conjunction with the accompanying drawings in which:

FIG. 1 is a block diagram of a distributed resource application.

FIG. 2 is a block diagram of a distributed resource application including an unintentional island.

FIG. 3 is a plot of distributed resource power output, engine throttle position, active speed bias and distributed resource frequency before, during and after an unintentional island trip in accordance with embodiments of the disclosed concept.

FIG. 4 is a block diagram of a distributed resource system in accordance with an embodiment of the disclosed concept.

FIG. 5 is a block diagram of the controller of FIG. 4.

FIGS. 6A-6B form a flowchart of an unintentional island protection routine for the controller of FIG. 5.

### DESCRIPTION OF THE PREFERRED EMBODIMENTS

As employed herein, the term “number” shall mean one or an integer greater than one (i. e., a plurality).

As employed herein, the term “processor” shall mean a programmable analog and/or digital device that can store, retrieve, and process data; a computer; a controller; a workstation; a personal computer; a microprocessor; a microcontroller; a microcomputer; a central processing unit; a mainframe computer; a mini-computer; a server; a networked processor; or any suitable processing device or apparatus.

As employed herein, the statement that two or more parts are “connected” or “coupled” together shall mean that the parts are joined together either directly or joined through one or more intermediate parts. Further, as employed herein, the statement that two or more parts are “attached” shall mean that the parts are joined together directly.

As employed herein, the term “distributed resource” shall mean an engine-generator; a distributed engine-generator; a MicroGrid engine-generator; or a Smart Grid engine-generator.

An engine-generator is the combination of an electrical generator and an engine (or prime mover) mounted together to form a single piece of equipment. This combination is also called an engine-generator set or a gen-set. In many contexts, the engine is taken for granted and the combined unit is simply called a generator.

Engine-generators are available in a wide range of power ratings. Engine-generators can include, for example, relatively small, hand-portable units that can supply several hundred watts of power, hand-cart mounted units that can supply several thousand watts, and stationary or trailer-mounted units that can supply over a million watts. Regardless of the size, generators can run on gasoline, diesel, natural gas, propane, bio-diesel, sewage gas, hydrogen or any suitable fuel. Most of the relatively smaller units are usually built to use gasoline as a fuel, and the relatively larger ones have various fuel types, including diesel, natural gas and propane (liquid or gas). Some engines may also operate on diesel and gas simultaneously (bi-fuel operation). Some engine-generators use a turbine as the engine, such as industrial gas turbines used in peaking power plants and micro-turbines used in some hybrid electric buses.

The disclosed concept is described in association with a particular engine-generator, although the disclosed concept is applicable to a wide range of distributed resources.

The disclosed concept senses an unintentional island condition, and causes a distributed resource to be removed from a utility grid.

The disclosed concept considers that a connected utility is an “infinite source”. Since a distributed resource represents a relatively small fractional percentage of utility power capacity, the distributed resource cannot have any significant impact on utility frequency.

Under normal operating conditions, the connected distributed resource frequency is governed by utility frequency. Therefore, increasing or decreasing engine speed causes an increase or decrease, respectively, of the electrical power delivered by the engine-generator, with no appreciable impact on system frequency. For example, by suitably alternately increasing and decreasing the speed bias to an engine-generator, sometimes referred to as “push-pull” herein, an unintentional island formation can be detected.

When an engine-generator is in parallel with a utility, it is locked into the dominant utility frequency, regardless of changes in speed bias. When the engine-generator is islanded, changes in speed bias will cause a change in frequency, which can be captured and used to trigger a protective trip of an engine-generator circuit breaker.

There is a fundamental difference in electrical power generation between a generator that is running alone and a generator that is connected in parallel with a utility grid. This fundamental difference makes the disclosed protective function possible.

When an engine-generator is in parallel with an “infinite” utility source, electro-magnetic forces keep the engine-generator frequency in perfect synchronization with the utility frequency. Therefore, any change in engine-generator throttle position will only change the power output of the generator, and never the frequency at which the generator is running

On the other hand, if an engine-generator is operating alone, it will carry whatever suitable load (e.g., in kW) is connected to its output. No more, no less. In this case, a change in engine-generator throttle position will cause a change in output frequency.

Thus, by suitably adjusting the engine-generator throttle open and closed, and looking for a change in frequency rather than a change in generator power output, the disclosed concept can relatively very quickly determine whether the utility source is present (normal operation) or is not present (unintentional island).

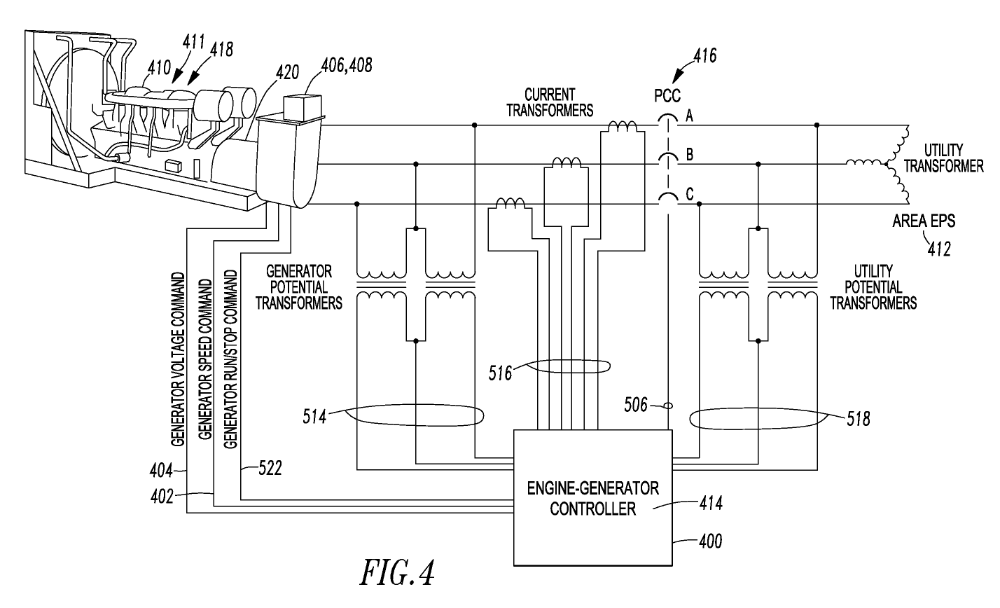

One non-limiting example embodiment of the disclosed protective function is an example switchgear-mounted engine-generator controller 400 as is shown in FIGS. 4 and 5. This controller 400 sends a speed bias signal 402 and a voltage bias signal 404 to an engine controller 406 and a voltage regulator 408, respectively, to control synchronizing operations, load control, and VAR (or power factor) control. In addition to “push-pull” functions, as will be described, other protective functions can be programmed into the engine-generator controller 400.

One example protective function is a known Delta Hz/Delta Time protective function that evaluates change in frequency per unit time. The Delta Hz/Delta Time function cannot reliably, in and of itself, detect all possible unintentional island conditions. Specifically, when the utility switch is opened, because the grid loads exactly equal distributed resource output, there would be no change in distributed resource frequency. Under these conditions, the Delta Hz/Delta Time function would not detect the island condition. This scenario, however, is detected by employing the disclosed active speed bias function. If there is some significant amount of power flow, in either direction, through the utility switch, then opening the switch will cause a step change to the load that the distributed resource is carrying and an attendant step change in distributed resource frequency, which is readily detected. The disclosed “push-pull” function ensures that when there is no power transfer across the utility switch, and the utility switch is open, the frequency deviation is artificially driven to a detectable level. The disclosed system can use, in part, the Delta Hz/Delta Time function for detection, but if the “push-pull” function was not there, then the Delta Hz/Delta Time function would not detect the island condition, under the above scenario.

Another known example protective function uses minimum/maximum setpoints of the expected utility frequency range. Over/Under Frequency protection is not associated with detecting an island condition. It is used to detect frequency deviation to a value that could cause equipment damage. For U.S. systems, Under Frequency is usually set to about 57.00 Hz and Over Frequency to about 63.00 Hz. The detection in the disclosed protective function assumes that the distributed resource is in parallel with a stable utility, and the setpoints are approximately 59.95 Hz and 60.05 Hz, respectively.

The disclosed concept alternately applies a positive and a negative speed bias to the engine 410, with the protective function looking to detect a change in frequency. If the utility (not shown) is present on the area EPS 412, no change in frequency will be detected. On the other hand, if the utility is not present on the area EPS 412 and an unintentional island has been formed, then a change in frequency will be detected by the disclosed protective function 414, and the point of common coupling (PCC) 416 will be immediately opened, thereby eliminating the unintentional island condition.

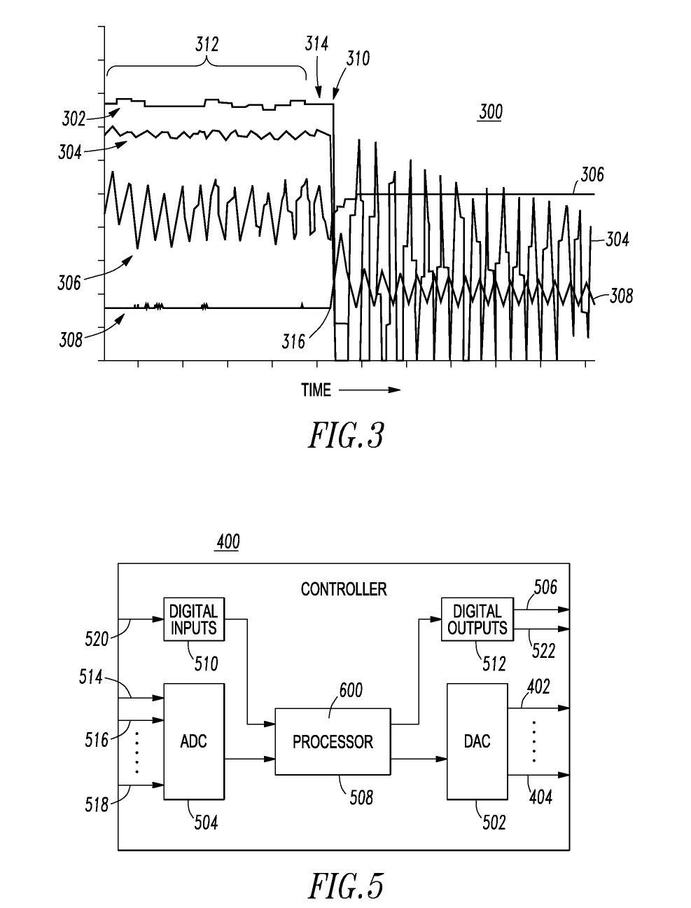

FIG. 3 shows a plot 300 of distributed resource (DR) power output 302, engine throttle position 304 (which follows active speed bias), active speed bias 306 and DR frequency 308 before, during 310 and after an unintentional island protection circuit breaker trip. Under steady state operations before a trip 312, the protective function active speed bias 306 causes the desired speed to form a saw tooth waveform as shown in FIG. 3, the output power (kW) 302 remains constant within the expected stability of the engine-generator 418 (FIG. 4), and the engine speed remains constant and locked onto the utility frequency 308 (e.g., 60 Hz).

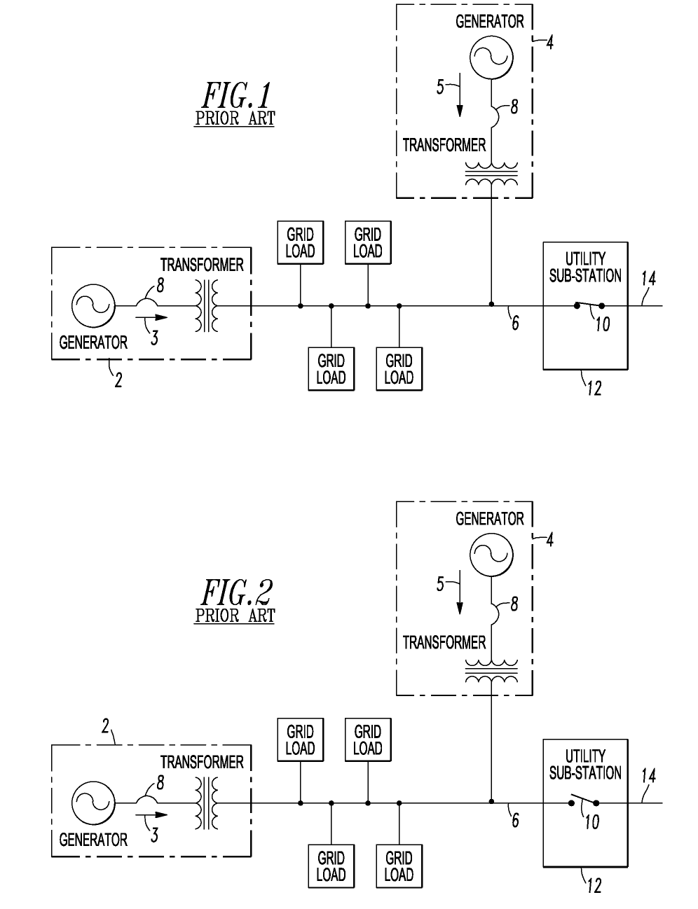

When the utility switch (not shown, but see the sub-station switch 10 of FIG. 2) is opened, an unintentional island is formed at 314 of FIG. 3. Due to the active speed bias 306, frequency 308 (and engine speed) immediately changes at 316, thereby causing the disclosed protective function 414 of FIG. 4 to trip the generator circuit breaker (PCC 416) of FIG. 4 at 310 of FIG. 3.

FIG. 5 shows the controller 400 of FIG. 4. The controller 400 includes the plural-channel digital-to-analog converter (DAC) 502, a plural-channel analog-to-digital converter (ADC) 504, a trip output 506 to the circuit breaker 416, a processor 508, digital inputs 510 and digital outputs 512. The ADC 504 includes a plurality of analog current and voltage inputs as shown in FIG. 4 including, for example, generator voltage and frequency signals 514, current signals 516, and utility voltage and frequency signals 518. These provide the frequency of the distributed resource, such as the example engine-generator 418. The DAC 502 provides the speed bias signal 402, which controls speed of the engine-generator 418, and the voltage bias signal 404. The digital inputs 510 include, for example, an auxiliary contact signal 520 from the circuit breaker 416. The digital outputs 512 include the trip output 506 and a generator run/stop command 522. The processor 508 executes the routine 600 and interfaces the DAC 502, the ADC 504, the digital inputs 510 and the digital outputs 512.

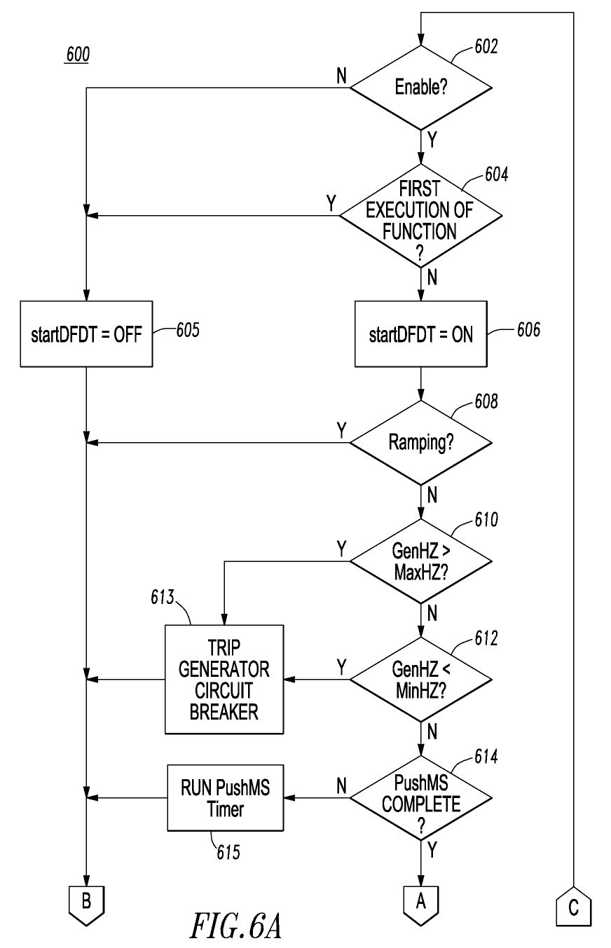

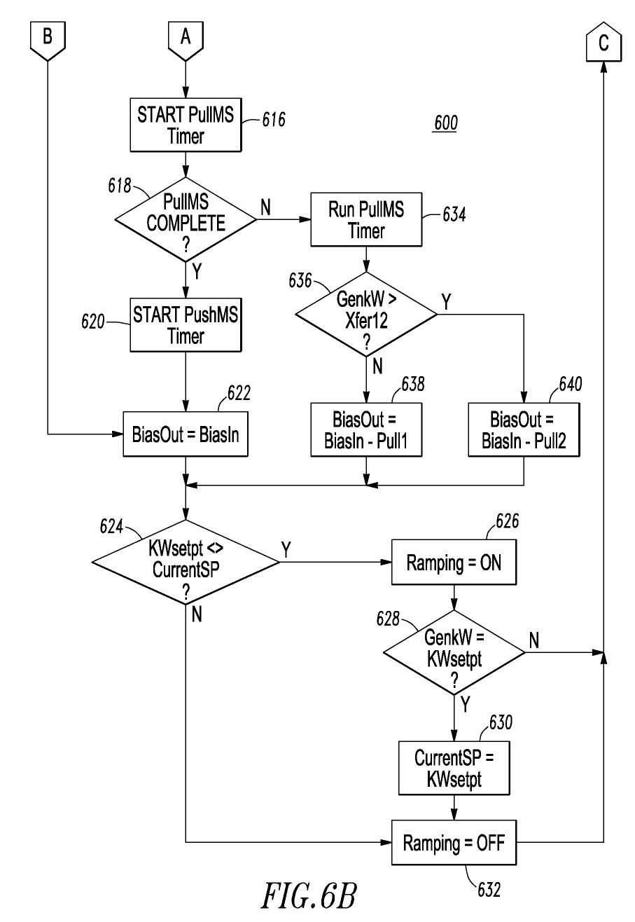

Referring to FIGS. 6A-6B, a protective function routine 600 of the controller 400 of FIG. 5 is shown. This routine 600 performs a repetitive push-pull on speed bias, causing the throttle 411 of the engine 410 (FIG. 4) to open and close slightly, and monitors Current Generator Frequency (GenHZ) at 610 and 612 looking for a frequency change to a value above Maximum allowed Generator Frequency (MaxHZ) or below Minimum allowed Generator Frequency (MinHZ). If such a change is detected, and an unintentional island has formed, then a Trip Generator Circuit Breaker signal (506 of FIGS. 4 and 5) is sent to the generator circuit breaker (PCC) 416 (FIG. 4) at 613, eliminating the unintentional island. This routine 600 also sends Permissive to Start ΔF/ΔT Function (startDFDT), enabling the supplemental ΔF/ΔT protection at 606.

The inputs to the routine 600 include Enable Function=Enable (Enable is usually connected to the Point of Common Coupling (PCC) circuit breaker 416, which is the circuit breaker that connects the generator 420 (FIG. 4) to the area EPS 412 (FIG. 4); an auxiliary contact (not shown) of the circuit breaker 416 is taken as an input 520 (FIG. 5) to the controller 400 to indicate when the generator 420 is in parallel with the area EPS 412); Desired Speed Bias=BiasIn (e.g., a numeric value that is used to control an analog output (speed bias signal 402) to the engine throttle 411 (FIG. 4); this can range from 0 to 26000, which corresponds to—5 VDC to +5 VDC, with 13000 being 0 VDC output; this value is controlled by other logic in the controller 400 and can be any suitable value, although it typically doesn't vary from 13000 by more than about 1000); Current Generator kW=GenkW (three-phase voltage signals are reduced to usable levels through potential transformers and those, in turn, are inputs measured by the controller 400; current transformers are used by the controller 400 to measure the individual phase currents, those signals are scaled, inside the controller 400, back to engineering units; the phase angle between voltage and current is determined to calculate power factor; the voltage, current and power factor measurements are then used to calculate GenkW); Generator kW Setpoint=KWsetpt (this number can vary widely according engine-generator size (in kW) and mode of operation); Current Generator Frequency=GenHz (generator frequency is a reading taken at the switchgear via the generator circuit breaker 416, after this signal has been put through potential transformers); Push-Pull Increment 1=Pull1 (this is the pull increment used to modify BaisIn at relatively lower generator output levels; generators are more sensitive to throttle changes at relatively lower power levels, so two increments are employed; this number will vary from engine type to engine type, and can even vary between different engines of identical type; an example value for this parameter is 4000); Push-Pull Increment 2=Pull 2 (this number will vary because of similar reasons as discussed, above, with Pull1; an example value for this parameter is 2000); Transition Point from 1 to 2 in kW=Xfer12 (this number will vary because of similar reasons as discussed, above, with Pull1; an example value for this parameter is 1000 kW); Pull Time in milliseconds=PullMS (this value will vary, although an unintentional island is sensed and the circuit breaker 416 is opened within two seconds of the formation of the unintentional island; an example value is 750 milliseconds); Push Time in milliseconds=PushMS (similar to PullMS, an example value is 750 milliseconds); Minimum allowed Generator Frequency=MinHz (this setpoint can vary regionally according to what the local utility may see as acceptable; a typical value is 59.95 Hz); and Maximum allowed Generator Frequency=MaxHz (this setpoint can vary regionally according to what the local utility may see as acceptable; a typical value is 60.05 Hz).

The outputs from the routine 600 include Speed Bias Output to Engine Generator=BiasOut (this is the speed bias signal 402 of FIG. 4; after being processed through a digital to analog converter 502 in the controller 400, this is the engine speed command); Generator Ramping Load On/Off=Ramping (this is calculated internally by the controller 400; basically, if the KWsetpt<>CurrentSP, then Ramping is true (either up or down) until GenkW=KWsetpt; when GenkW is equal to KWsetpt, then KWsetpt is copied to the internal variable CurrentSP for future comparisons and the system is no longer ramping); Permissive to Start ΔF/ΔT Function=startDFDT; and Trip Generator Circuit Breaker=TripGen.

First, at 602 of FIG. 6A, the routine 600 checks if Enable is true. If so, the routine 600 is enabled. Then at 604, it is determined if this is the first execution of the routine 600. If so, then startDFDT is set “off” at 605 before execution resumes at 622 of FIG. 6B. Otherwise, startDFDT is set “on” at 606. Next, at 608, it is determined if Ramping is true. If so, then execution resumes at 622 of FIG. 6B. Generator Ramping Load On/Off (Ramping) is the indication that the engine-generator 418 (FIG. 4) is changing to a new load setting. Under this condition, the push-pull function is suspended. Ramping the generator 420 onto load is a prolonged push function, ramping the generator 420 off load is a prolonged pull function, so cycling the engine throttle 411 is not necessary for protection.

On the other hand, if Ramping is false at 608, then, at 610, it is determined if GenHZ exceeds MaxHZ. If so, then the generator circuit breaker 416 is tripped at 613. Otherwise, if GenHZ is not greater than MaxHZ, but is less than MinHZ at 612, then the generator circuit breaker 416 is tripped at 613 and execution resumes at 622 of FIG. 6B. Otherwise, if GenHz is equal to either MaxHZ or MinHZ, or is within that range, then, at 614, it is determined if PushMS is complete. Push Time in milliseconds (PushMS) defines how long the Speed Bias Output to Engine Generator (BiasOut) is released from the pull, such that Speed Bias Output to Engine Generator (BiasOut) is equal to Desired Speed Bias (BiasIn). If not, then at 615, PushMS timer is run and execution resumes at 622 of FIG. 6B. Otherwise, execution resumes at 616 of FIG. 6B where PullMS timer is started. Pull Time in milliseconds (PullMS) defines how long the Speed Bias Output to Engine Generator (BiasOut) will be decreased by Push-Pull Increment 1 (Pull1) or Push-Pull Increment 2 (Pull2), as described below.

Run PushMS Timer 615 and Run PullMS Timer 634 continue running the corresponding timers. These define the period of the Push-Pull function. While the PushMS Timer is running, the analog speed bias input (BiasIn) is passed unchanged to the analog speed bias output (BiasOut). When the PushMS Timer reaches its preset (PushMS), the pull cycle begins. There, the PullMS Timer is started at 616, and BiasIn is decremented by the pull increment (either Pull1 or Pull2), and the result is sent to BiasOut. When this timer reaches its preset (PullMS), the push cycle begins again, and so forth.

Next, at 618, it is determined if PullMS is complete. If so, then PushMS Timer is started at 620. Next, at 622, BiasOut is set equal to BiasIn. Then, at 624, it is determined if KWsetpt is different than CurrentSP. If so, then Ramping is set on at 626. Otherwise, Ramping is set off at 632. After 626, it is determined if GenkW is equal to KWsetpt at 628. If not, then execution resumes at 602 of FIG. 6A. Otherwise, CurrentSP is set equal to KWsetpt at 630. Then, at 632, Ramping is set “off” after which execution resumes at 602 of FIG. 6A.

On the other hand, if PullMS was not complete at 618, then, at 634, PullMS Timer is run at 634. Then, at 636, it is determined if GenkW is greater than Xfer12. If not, then BiasOut is set equal to BiasIn less Pull1 at 638. Otherwise, if GenkW is greater than Xfer12, then BiasOut is set equal to BiasIn less Pull2 at 640. The Desired Speed Bias (BiasIn) is the basic desired speed command, before it is modified by the routine 600. Because of different engine dynamics at different loads, the routine 600 allows for a change in the way that the engine throttle 411 is cycled. When Current Generator kW (GenkW) is below Transition Point from 1 to 2 (Xfer12) in kW, Push-Pull Increment 1 (Pull1) is subtracted from Desired Speed Bias (BiasIn) and the resulting speed bias is sent to Speed Bias Output to Engine Generator (BiasOut). When Current Generator kW (GenkW) is above Transition Point from 1 to 2 in kW (Xfer12), Push-Pull Increment 2 (Pull2) is used. After either 638 or 640, execution resumes at 624.

The final result of the protective function routine 600 is a speed bias output (BiasOut) to the engine throttle 411 that cycles up and down, for example and without limitation, at about 12% of its range about every 1.5 seconds. This bias is enough to cause a change in generator frequency beyond the circuit breaker trip settings when the engine-generator 418 is islanded, but is not enough to cause a major disturbance in power output by the engine-generator 418 when it is in parallel with the area EPS 412. It will be appreciated that the non-limiting example 12% value and example 1.5 second time can vary for other types of engine-generators and other types of PCCs.

The disclosed concept provides IEEE 1547 compliance for unintentional islanding since the “push-pull” of the engine throttle 411 by the protective function routine 600 takes place about every 1.5 seconds, in order to be able to detect separation from the utility source (not shown) and open the generator breaker (PCC) 416 within 2 seconds.

The disclosed protective function routine 600 does not impact normal engine-generator 418 operation.

Distributed resource sites that are connected on a long-term basis to the utility grid usually are in the business of selling power to the local utility company. Hence, maximizing engine-generator power output is paramount. If the protective function causes a reduction in overall power output, then the protective function would be less desirable to its prospective users. At the same time, the throttle push-pull function is sufficient to the point that if the engine-generator is islanded from the utility, then the protective function will push or pull generator frequency beyond the corresponding trip settings. The disclosed push-pull adjustment and duration accomplish both of these goals.

The disclosed protective function causes no undue wear under normal operating conditions of a number of components of the engine-generator.

IEEE 1547 is based on UL 1741, which specifies that the protection must be active. Hence, in order to obtain UL certification for compliance, it must be demonstrated that the protection is not a passive function, such as monitoring for a change in frequency over time (DF/DT). Other standards, such a California Rule 21, specify that such protection must be an active function.

“Pumping” the engine throttle about every 1.5 seconds does not lead to an early throttle failure. The disclosed concept ensures that the protective function is strong enough to cause the generator breaker to trip when an unintentional island exists, but gentle enough not to cause early throttle failure under normal operations.

In the United States, utility grid frequency is relatively very constant. It is unusual to see variances of more than a few hundredths of a Hertz. Typical minimum and maximum settings for this protective function are from about 59.95 Hz (Minimum allowed Generator Frequency=MinHz) to about 60.05 Hz (Maximum allowed Generator Frequency=MaxHz). However, there is some variance in what is considered a normal variance from region to region in the United States. As such, in deploying the disclosed protective function, minimum and maximum settings can depend on what is considered to be a normal utility frequency variance for a given region. The goal of this setting is to be as sensitive as possible to an unintentional island condition without causing unnecessary interruption to the operation of the engine-generator.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof

What is claimed is:

1. A method of detecting an unintentional island condition of a distributed resource of a utility grid, said method comprising:
actively biasing engine-generator speed of said distributed resource; and
detecting a predetermined change in frequency of said distributed resource and responsively indicating said unintentional island condition.

2. The method of claim 1 further comprising:
disconnecting said distributed resource from said utility grid responsive to said detecting.

3. The method of claim 2 further comprising:
providing said detecting and said disconnecting within two seconds of formation of said unintentional island condition.

4. The method of claim 1 further comprising:
employing an engine-generator as said distributed resource; and
providing no impact to said engine-generator during normal operation without said unintentional island condition.

5. The method of claim 1 further comprising:
employing an engine-generator as said distributed resource; and
providing no undue wear to a number of components of said engine-generator during normal operation without said unintentional island condition.

6. The method of claim 5 further comprising:
employing a throttle as one of the number of components of said engine-generator; and
providing no undue wear to said throttle.

7. The method of claim 1 further comprising:
employing an engine-generator as said distributed resource; and
performing said detecting by sensing frequency deviation of said engine-generator above or below predetermined limits.

8. The method of claim 1 further comprising:
employing an engine-generator having a speed bias as said distributed resource; and
employing as said actively biasing engine-generator speed periodically adjusting said speed bias by a predetermined percentage thereof

9. A protective apparatus for a distributed resource of a utility grid, said protective apparatus comprising:
a processor comprising:
an input structured to input frequency of said distributed resource,
a first output structured to control speed of said distributed resource,
a second output, and
a routine structured to actively bias engine-generator speed of said distributed resource through said first output, and detect a predetermined change in the frequency of said distributed resource from said input and responsively indicate said unintentional island condition through said second output; and
a circuit interrupter.

10. The protective apparatus of claim 9 wherein said second output is structured to cooperate with said circuit interrupter to disconnect said distributed resource from said utility grid responsive to detecting the predetermined change and indicating said unintentional island condition.

11. The protective apparatus of claim 10 wherein said routine and said circuit interrupter are cooperatively structured to detect the predetermined change and disconnect said distributed resource from said utility grid within two seconds of formation of said unintentional island condition.

12. The protective apparatus of claim 9 wherein said distributed resource is an engine-generator; and wherein said routine is structured to provide no impact to said engine-generator during normal operation without said unintentional island condition.

13. The protective apparatus of claim 9 wherein said distributed resource is an engine-generator; and wherein said routine is structured to provide no undue wear to a number of components of said engine-generator during normal operation without said unintentional island condition.

14. The protective apparatus of claim 13 wherein one of the number of components of said engine-generator is a throttle; and wherein said routine is structured to provide no undue wear to said throttle.

15. The protective apparatus of claim 9 wherein said distributed resource is an engine-generator; and wherein said routine is structured to sense frequency deviation of said engine-generator above or below predetermined limits.

16. The protective apparatus of claim 9 wherein said distributed resource is an engine-generator having a speed bias; and wherein said routine is structured to periodically adjust said speed bias by a predetermined percentage thereof

17. A controller for a distributed resource of a utility grid, said controller comprising:
a processor;
an input structured to input frequency of said distributed resource;
a first output structured to control speed of said distributed resource;
a second output; and
a routine executed by said processor and structured to actively bias engine-generator speed of said distributed resource through said first output, and detect a predetermined change in the frequency of said distributed resource from said input and responsively indicate said unintentional island condition through said second output.

18. The controller of claim 17 wherein said distributed resource is an engine-generator having a speed bias; and wherein said routine is structured to periodically adjust said speed bias by a predetermined percentage thereof

19. The controller of claim 17 wherein said routine is structured to detect the predetermined change and responsively indicate said unintentional island condition within about 1.5 seconds of formation of said unintentional island condition.

20. The controller of claim 17 wherein said second output is structured to trip open a circuit interrupter.
